(19) United States
(12) Patent Application Publication
(10) Pub. No.: US 2020/0370405 A1
(43) Pub. Date: Nov. 26, 2020

(54) METHODS AND APPLICATIONS OF WIDE PARTICLE-SIZE DISTRIBUTION PROPPANT MATERIALS IN SUBTERRANEAN FORMATIONS

(71) Applicant: Halliburton Energy Services, Inc., Houston, TX (US)

(72) Inventors: Philip D. Nguyen, Houston, TX (US); Ubong Akpan Inyang, Humble, TX (US); Janette Cortez Montalvo, Porter, TX (US); Michael W. Sanders, Houston, TX (US)

(21) Appl. No.: 16/421,378

(22) Filed: May 23, 2019

(51) Int. Cl. E21B 43/267; C09K 8/80

(52) U.S. Cl. CPC E21B 43/267; C09K 8/805

(57) ABSTRACT

Systems and methods for treating subterranean formations using proppants. More particularly, the systems and methods use sand or other particles having a wide particle-size distribution as a proppant for treating subterranean formations, including unconventional formations. In some embodiments, the methods comprise: providing a treatment fluid comprising a base fluid and unsieved proppant material; introducing the treatment fluid into a well bore penetrating at least a portion of a subterranean formation; and depositing at least a portion of the unsieved proppant material in at least a portion of the subterranean formation.

### BACKGROUND

The present disclosure relates to systems and methods for treating subterranean formations using proppants.

Wells in hydrocarbon-bearing subterranean formations, especially unconventional formations, often require stimulation to produce hydrocarbons at acceptable rates. One stimulation treatment of choice is hydraulic fracturing treatments. In hydraulic fracturing treatments, a fracturing fluid, which also functions as a proppant carrier fluid, is pumped into a producing zone at a rate and pressure such that one or more fractures are formed and/or extended in the zone. Typically, proppant particulates suspended in a portion of the fracturing fluid are also deposited in the fractures. These proppant particulates help prevent the fractures from fully closing so that conductive channels are formed and maintained such that the produced hydrocarbons can flow at economic rates.

In some shale fracturing treatments, large amounts of water or other fluids (e.g., an average of 1 million gallons per fracturing stage) are pumped at high rates and pressures in order to provide sufficient energy downhole to form multiple fractures of the desired geometries in the formation. To create fractures in certain types of formations (e.g., unconventional formations or low permeability formations) or to create complex fracture network in subterranean formations, operators may rely on the use of a low viscosity fluid (e.g., slickwater fluids) as the main fracturing fluid, and due to the relatively small fracture widths formed, the use of small size proppant (e.g., 100-mesh) as the proppant has become commonplace. Large amounts of proppant and fluid are often used in these operations. Providing the large amounts of pumping power, water, proppants, and fluid additives (e.g., friction reducers) for these operations, and the disposal of water flowing back out of the formation after these treatments, are often costly and time-consuming, and make fracturing operations economically impractical in some circumstances. There can be further time and monetary cost to get the designated proppant ready for use in a treatment fluid as said proppant traditionally has to undergo a sieving process in order to filter out any proppants not within a designated range of sizes to be used after obtaining the proppant (e.g., mining sand from a sand mine).

### BRIEF DESCRIPTION OF THE DRAWINGS

These drawings illustrate certain aspects of some of the embodiments of the present disclosure and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is a graph depicting particle size distribution curves in accordance with certain embodiments of the present disclosure.

FIG. 4 is an illustration of slot models simulating an opening fracture in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates to systems and methods for treating subterranean formations using proppants. More particularly, the present disclosure relates to systems and methods for using sand or other particles having a wide particle-size distribution as a proppant for treating subterranean formations, including unconventional formations.

Typically, fracturing sand proppant with a narrow particle size distribution, such as 70/170-mesh, 40/70-mesh, 30/50-mesh, or 20/40-mesh, may be used in hydraulic fracturing treatments. The small-sized fracturing sand slurry may be injected first, followed by the injection of the larger-sized sand particles to allow the smaller particles to enter and be placed inside a far well bore region of the created fractures, whereas the larger particles are placed in the near wellbore region. In some instances, prior to their use in these applications, sand and other proppants are sieved or otherwise processed, among other reasons, to remove particles that are larger than or smaller than the targeted particle size range and/or distribution. The methods provided in the present disclosure may generally comprise providing an aqueous solution comprising a proppant material such as sand to “prop” open the natural fractures and/or the induced fractures present in said subterranean formation.

The proppant material used in the methods of the present disclosure may have a wide particle-size distribution or, in some instances, may be selected and/or used in a subterranean formation without regard for the particle size distribution of the proppant at all. As defined herein, a “wide particle-size distribution” may refer to a particle size distribution of the proppant material ranging from about 0.01 microns and about 2,000 microns, wherein at least a portion of the particles comprises the size of about the lower end and the size of about the upper end of said range of particle size distribution. In embodiments, particles with particles sizes between about 100 microns to about 1 mm may be designated as “larger particles,” and particles with particles sizes of about 100 microns or less may be designated as “smaller particles.” The larger particles may behave differently than the smaller particles in a wellbore environment. The proppant material may comprise larger and/or smaller particles. There may be a suitable tolerance regarding the limits to the particle size distribution. Without limitations, a suitable tolerance may be about 5%, 10%, 20%, 30%, 40%, or 50%. For example, the proppant material may comprise a designated amount of particles wherein the smallest particle size may be about 10% larger than the lower end of the range of the disclosed particle size distribution. In another embodiment regarding the designated amount of particles, the largest particle size may be about 30% smaller than the upper end of the range of the disclosed particle size distribution. Each individual particle may have a particle size that differs from the remaining particles. As disclosed, the proppant material may comprise anon-uniform composition of particle sizes. In embodiments, the proppant material may comprise mesh sizes ranging from about 10 mesh to about 1,000 mesh, wherein at least a portion of the particles comprises the mesh size of the lower end and the mesh size of the upper end of said range of mesh sizes. Conventional proppant material used may comprise of relatively uniform particle sizes. For example, certain conventional proppant materials may have a mesh size of 70, wherein particles up to a certain size may pass through a sieve with that mesh size. With regards to the present disclosure, the proppant material may comprise particles wherein the particle sizes collectively align with a plurality of mesh sizes. The disclosed proppant material may not be compatible with a sieve comprising a high mesh size as such a sieve would prohibit a portion of the proppant material from passing through. With regards to the present disclosure, the wide particle-size distribution sand may be unsieved, wherein the proppant material, such as sand, has not undergone a sieving process and/or has not been filtered or sorted. In certain embodiments, the unsieved proppant material may undergo a process (which may employ coarse screen-like equipment or processes) to remove debris present in the sand and/or particles of sizes greater than about 2 mm. In certain embodiments, the unsieved proppant material, such as sand obtained from a sand mine, may undergo a washing process to remove clay minerals (e.g., kaolinite, illite, smectite, feldspar, etc.) and impurities from the sand. However, in those embodiments where such processes are used, proppant material may still be considered “unsieved”.

Without limitations, the unsieved proppant material may be obtained from drill cuttings, desert sand, dredged river sand, beach sand, waste material from a sieving operation to produce synthetic proppant, ground-up plastics and/or rubbers, fly ash, or any particulate material within the size range which is capable of being transported downhole and which is capable of maintaining a conductive pathway from the formation to the wellbore. The unsieved proppant material may be introduced into the subterranean formation in the form of a treatment (e.g., as a component of a treatment fluid).

Among the many potential advantages to the methods and compositions of the present disclosure, only some of which are alluded to herein, the methods, compositions, and systems of the present disclosure may enhance the vertical distribution of sand in created fractures during a fracturing process to overcome the settling tendency of a narrow mesh size distribution of conventional sand. In some embodiments, the larger-sized particles of the proppant material (e.g., particles having a particle sizes between about 100 microns to about 1 mm) may have a tendency to settle near the entrance of a fracture, and the smaller-sized particles of the proppant material (e.g., particles having a particle sizes of about 100 microns or less) may continue to be transported deeper into the formation via the fracture. Some embodiments of the present disclosure may enhance the vertical distribution of the proppant material in fractures, which may allow smaller-sized particles to further advance into micro-fractures as larger-sized particles settle in an area near a wellbore, as discussed further below. In embodiments, settling and suspension of the slurry may occur substantially simultaneously as a function of particle size, fluid viscosity, and/or fluid velocity. In some embodiments, the methods and compositions of the present disclosure may facilitate performing or providing the benefits of multiple treatments with a single treatment fluid containing a single wide particle size distribution. The provided treatment fluid and proppant material may reduce the need for injecting fluids in stages based on mesh size, as the proppant material used in the present disclosure comprises a plurality of particles that have a single, wide particle-size distribution which are distributed natural via the critical velocity for a given fluid viscosity and/or density, sand density, sand concentration, sand size, etc.

For example, in certain existing hydraulic fracturing treatments in shale formations, slickwater fracturing fluid containing micro-proppant may be first injected to place the micro-proppant in the natural or induced microfractures. Next, slickwater fracturing fluid containing 100-mesh sand may be injected to place the 100-mesh sand in the created primary fractures or small fissures. And last, slickwater fracturing fluid containing 40/70-mesh (or 30/50 mesh) sand may be injected to place this large-sized sand near the wellbore in the created primary fracture.

In contrast, the methods and compositions of the present disclosure may use a single fracturing fluid that comprises particles of a wide particle size distribution and allow gravity to encourage a settling tendency of particles in a low viscosity fluid (e.g., viscosity of about 20 cP or less), thereby allowing the large mesh size sand particles to settle near the wellbore in the created primary fracture. The smaller mesh size sand particles may continue to be transported forward and be placed farther inside the fracture, and micro-mesh size sand may enter the microfractures deepest in the formation. In some cases, the methods and systems of this disclosure may be less expensive as compared to certain other methods and compositions conventionally used for such treatments. All sand sizes, rather than only a specific range of sand sizes, can be utilized as described in the present disclosure for shale fracturing, thereby minimizing certain amounts of sand to be considered as waste or unusable.

In certain embodiments, the treatment fluids used in the methods and systems of the present disclosure may comprise an unsieved proppant material (e.g., unsieved sand) or other proppant material having a wide particle size distribution to be placed within fractures in the formation. In certain embodiments, the treatment fluids optionally may comprise one or more proppant particulates (e.g., sized or sieved proppant particulates) in addition to the proppant material of the present disclosure, among other reasons, to be placed within fractures in the formation. Alternatively, a separate treatment fluid comprising such proppant particulates may be applied before and/or after the application of a treatment fluid comprising the proppant material of the present disclosure. In some embodiments, a plurality of proppant particulates may reside and/or be deposited in a fracture treated according to the methods of the present disclosure using another treatment fluid. Examples of materials that may be suitable for use as proppant materials of the present disclosure and/or other proppant particulates include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and/or any combination thereof. In certain embodiments, the proppant particulates may have an average size larger than that of micro-proppant particulates (discussed below), and may range to greater than about 100 mesh, U.S. Sieve Series.

In certain embodiments, the treatment fluids optionally may comprise one or more microproppant materials in addition to the proppant material of the present disclosure, among other reasons, to be placed within microfractures in the formation. Alternatively, a separate treatment fluid comprising the microproppant materials may be applied before and/or after the application of a treatment fluid comprising the unsieved proppant material. Such microproppant materials may comprise particulates that are pumped into the formation with a carrier fluid or may comprise particulates formed in situ in the formation. In some embodiments, such microproppant particulates may have an average size of less than about 100 mesh. In certain embodiments, the microproppant particulates may have particle sizes smaller than 100 mesh (149 μm), and in certain embodiments may have particle sizes equal to or smaller than 200 mesh (74 μm), 230 mesh (63 μm) or even 325 mesh (44 μm). Examples of microproppant materials that may be suitable for use in certain embodiments of the present disclosure include, but are not limited to, fly ash, silica, alumina, fumed carbon, carbon black, graphite, mica, titanium dioxide, metal-silicate, silicate, kaolin, talc, zirconia, boron, hollow microspheres, glass, calcined clays, partially calcined clays, and any combination thereof.

The fluids used in the methods and systems of the present disclosure may comprise any base fluid known in the art, including aqueous base fluids and/or non-aqueous base fluids. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may comprise water from any source and may comprise any components other than water that do not adversely impact the proppant used in the particular application of the present disclosure. Such aqueous fluids may comprise fresh water, salt water (e.g., water containing one or more salts dissolved therein), brine (e.g., saturated salt water), formation produced water, seawater, or any combination thereof. In most embodiments of the present disclosure, the aqueous fluids comprise one or more ionic species, such as those formed by salts dissolved in water. For example, seawater and/or produced water may comprise a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, breakers, biocides, scale inhibitors, and other additives included in the fluid. One of ordinary skill in the art, with the benefit of this disclosure, will recognize when such density and/or pH adjustments are appropriate. Examples of non-aqueous base fluids that may be suitable for use in the methods and systems of the present disclosure include, but are not limited to, oils, hydrocarbons, organic liquids, and the like. In certain embodiments, the base fluids may comprise a mixture of one or more fluids and/or gases, including but not limited to emulsions, foams, and the like.

In certain embodiments, the treatment fluids used in the methods and systems of the present disclosure optionally may comprise any number of additional additives. Examples of such additional additives include, but are not limited to, salts, surfactants, acids, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, viscosifying or gelling agents, breakers, weighting agents, relative permeability modifiers, resins, wetting agents, coating enhancement agents, filter cake removal agents, antifreeze agents (e.g., ethylene glycol), and the like. In certain embodiments, one or more of these additional additives (e.g., a crosslinking agent) may be added to the treatment fluid and/or activated after the viscosifying agent has been at least partially hydrated in the fluid. A person skilled in the art, with the benefit of this disclosure, will recognize the types of additives that may be included in the fluids of the present disclosure for a particular application.

The treatment fluids of the present disclosure may be prepared using any suitable method and/or equipment (e.g., blenders, mixers, stirrers, etc.) known in the art at any time prior to their use. The fluids may be prepared at least in part at a well site or at an offsite location. In certain embodiments, any suitable components of the fluid may be metered directly into a base fluid to form the fluid or solution. In certain embodiments, a base fluid may be mixed with the other suitable components of the treatment fluid (e.g., the proppant materials of the present disclosure and/or any optional additives) at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the fluids of the present disclosure may be prepared, either in whole or in part, at an offsite location and transported to the site where the treatment or operation is conducted. In introducing a fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the wellbore to form a treatment fluid prior to entering the formation. In either such case, the treatment fluid is deemed to be introduced into at least a portion of the subterranean formation for purposes of the present disclosure.

The present disclosure provides methods for using the treatment fluids to carry out subterranean treatments in conjunction with a variety of subterranean operations, including but not limited to, hydraulic fracturing operations, fracturing acidizing operations to be followed with proppant hydraulic fracturing operations, and the like. In certain embodiments, a treatment fluid may be introduced into a subterranean formation. In some embodiments, the treatment fluid may be introduced into a well bore that penetrates a subterranean formation. The subterranean formations treated may comprise any type of rock, including but not limited to ultra-tight sandstone, shale, carbonate, coal, shale muds, laminated sand/shale, and any combination thereof.

In certain embodiments involving fracturing treatments, a treatment fluid may be introduced at a pressure sufficient to create or enhance one or more fractures within the subterranean formation (e.g., hydraulic fracturing). In other embodiments, the methods and compositions of the present disclosure may be used to treat pre-existing fractures, or fractures created using a different treatment fluid. In certain of these embodiments, a treatment fluid comprising all, some, or none of the components listed above may be introduced at a pressure sufficient to create or enhance one or more fractures within the formation, and one or more of the treatment fluids comprising a proppant material of the present disclosure (e.g., unsieved sand) subsequently may be introduced into the formation.

In certain embodiments, the methods and compositions of the present disclosure may be used to create or enhance and treat microfractures within a subterranean formation in fluid communication with a primary fracture in the formation. In certain embodiments, these microfractures may be pre-existing microfractures, and may be treated in a similar manner to those discussed above. In other embodiments, a treatment fluid comprising a proppant material of the present disclosure (e.g., unsieved sand) may be introduced into a subterranean formation at or above a pressure sufficient to create one or more microfractures. In these embodiments, the smaller particles of the proppant material may be deposited within the microfractures in the formation.

In some embodiments, a treatment fluid that comprises a proppant material of the present disclosure (e.g., unsieved sand) with particle sizes of less than about 1 mm may be introduced at a pressure sufficient to create or enhance one or more fractures within the subterranean formation (e.g., hydraulic fracturing). When the proppant material of the present disclosure is used, the smaller-sized particles (e.g., particle sizes less than about 100 microns) may be deposited into microfractures while the larger-sized particles may settle in the dominant fractures near the wellbore. In another embodiment, a method of hydraulic fracturing may comprise injecting a substantially sand-free or particulate-free pad fluid into a formation at an injection rate above the fracture gradient to create at least one dominant fracture and/or a microfracture. In some embodiments, the pad fluid may be aqueous-based. The method may further include injecting a fracturing fluid comprising a proppant material of the present disclosure (e.g., unsieved sand or a man-made proppant that has not been sieved or otherwise has a wide particle size distribution with particle sizes of less than about 1 mm) to create and/or extend the induced fractures and microfractures. The particles in the proppant material having particle sizes less than about 100 microns may act as a micro-proppant and access the microfractures while the larger-sized particles may settle in the dominant fractures.

In some embodiments, a method may comprise injecting a fluid comprising small-sized, high strength proppant into a well bore penetrating a portion of a subterranean formation that includes an induced fracture, wherein the high strength proppant material may have a particle size smaller than about 30 mesh. The method may further comprise injecting into the well bore or formation a fluid comprising a proppant material of the present disclosure (e.g., unsieved sand), wherein the proppant material forces at least a portion of the small-sized high strength proppant from the previous fluid further into the fractures. The method may further comprise injecting into the well bore or formation a fluid comprising large-sized, high strength proppant that may settle at a near-wellbore region and displace the proppant material of the present disclosure further into the formation, wherein the high strength proppant material may have a particle size larger than about 30 mesh. This may, among other benefits, maintain relatively high conductivity flow paths connecting to the wellbore.

In some embodiments, the methods may further comprise injecting a substantially sand-free or particulate-free sweep or spacer fluid into a formation before or after the fluid comprising the proppant material of the present disclosure. Such sweep or spacer fluids may, among other benefits, facilitate the desired placement of the proppant material of the present disclosure in a particular region of the formation and to prevent premature screenout that causes incomplete placement of the desired amount of proppant to be placed in the induced fractures.

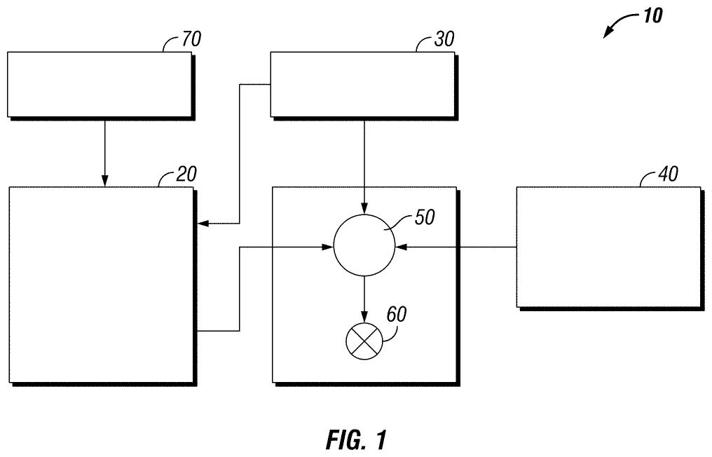

Certain embodiments of the methods and compositions disclosed herein may use one or more components or pieces of equipment associated with the preparation, delivery, recapture, recycling, reuse, and/or disposal of the disclosed compositions. For example, and with reference to FIG. 1, the disclosed methods and compositions may directly or indirectly be associated with an exemplary fracturing system 10, according to one or more embodiments that involve fracturing treatments or the treatment of pre-existing fractures. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant (e.g., microproppant material or larger proppant particulates) for combination with the fracturing fluid. With regards to the present disclosure, the proppant source 40 may comprise one or more proppant materials having a wide particle size distribution such as unsieved sand. The system may also include additive source 70 that provides one or more additives to alter the properties of the fracturing fluid. For example, the one or more additives can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including the unsieved sand from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 to source from one, some or all of the different sources at a given time and may facilitate the preparation of fracturing fluids in accordance with the present disclosure using continuous mixing or “on-the-fly” methods. Thus, for example, the pumping and blender system 50 can provide just fracturing fluid into the well at sometimes, just proppants or unsieved sand at other times, and combinations of those components at yet other times.

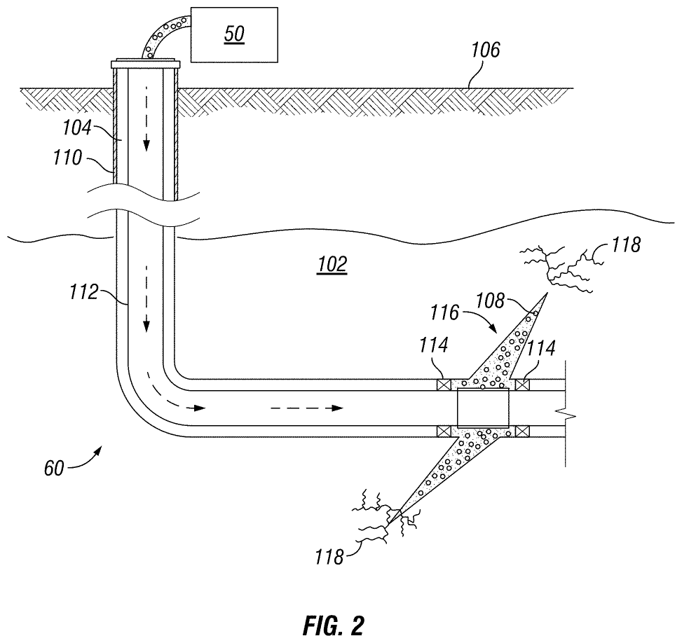

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the well bore 104. The pump and blender system 50 is coupled to the work string 112 to pump the fracturing fluid 108 into the well bore 104. The work string 112 may include coiled tubing, jointed pipe, and/or other structures that allow fluid to flow into the well bore 104. The work string 112 can include flow control devices, bypass valves, ports, and or other tools or well devices that control a flow of fluid from the interior of the work string 112 into the subterranean zone 102. For example, the work string 112 may include ports adjacent the well bore wall to communicate the fracturing fluid 108 directly into the subterranean formation 102, and/or the work string 112 may include ports that are spaced apart from the well bore wall to communicate the fracturing fluid 108 into an annulus in the well bore between the work string 112 and the well bore wall.

The work string 112 and/or the well bore 104 may include one or more sets of packers 114 that seal the annulus between the work string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. In certain embodiments, the fracturing fluid 108 may include unsieved sand, which may facilitate hydrocarbon flow within fractures 116 according to the methods described therein. The unsieved sand and/or other proppant particulates in the fracturing fluid 108 may enter the fractures 116 where they may remain after the fracturing fluid flows out of the well bore. The unsieved sand and/or other proppant particulates may “prop” fractures 116 such that fluids may flow more freely through the fractures 116. Additionally, one or more microfractures 118 branching off of and in communication with fractures 116 may be created in a similar fashion. In certain embodiments, the unsieved sand may additionally facilitate flow within the microfractures 118 according to the methods described therein.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLE 1

Two local, unsieved sand samples were obtained from sand mines located in west Texas. Each of these unsieved sand samples were analyzed to characterize their particle size distributions, which are shown in Table 1. As shown below, approximately 50% of the particles of sand present in Sample 1 were larger than 304 μm in diameter, and the remaining 50% were smaller than that. Approximately 50% of the particles of sand present in Sample 2 were larger than 241 μm in diameter, and the remaining 50% were smaller than that.

TABLE 1

| Sand Mine | D10 | D50 | D90 |
|---|---|---|---|
| Sample | (μm) | (μm) | (μm) |
| 1 | 28.6 | 304 | 528 |
| 2 | 24.3 | 241 | 387 |

The following tables show the mesh sizes and the percent quantity for each unsieved sand sample using equipment such as a sieve shaker. Table 2 depicts the data for the sand in Sample 1. Table 3 depicts the data for sand in Sample 2.

TABLE 2

| | Trial 1 | Trial 2 |
|---|---|---|
| 30 Mesh | 0.1 | 0.12 |
| 40 Mesh | 3.28 | 2.76 |
| 50 Mesh | 20.95 | 17.73 |
| 70 Mesh | 47.73 | 46.81 |
| 80 Mesh | 14.09 | 14.74 |
| 100 Mesh | 7.35 | 8.53 |
| 120 Mesh | 4.07 | 5.18 |
| 140 Mesh | 1.2 | 1.74 |
| 200 Mesh | 0.75 | 1.45 |
| Pan | 0.64 | 0.97 |

TABLE 3

| | Trial 1 | Trial 2 |
|---|---|---|
| 30 Mesh | 0.02 | 0.02 |
| 40 Mesh | 1.91 | 1.66 |
| 50 Mesh | 18.22 | 16.89 |
| 70 Mesh | 44.17 | 43.78 |
| 80 Mesh | 17.31 | 17.83 |
| 100 Mesh | 10.32 | 11.17 |
| 120 Mesh | 5.37 | 5.83 |
| 140 Mesh | 1.39 | 1.57 |
| 200 Mesh | 0.89 | 1.02 |
| Pan | 0.6 | 0.82 |

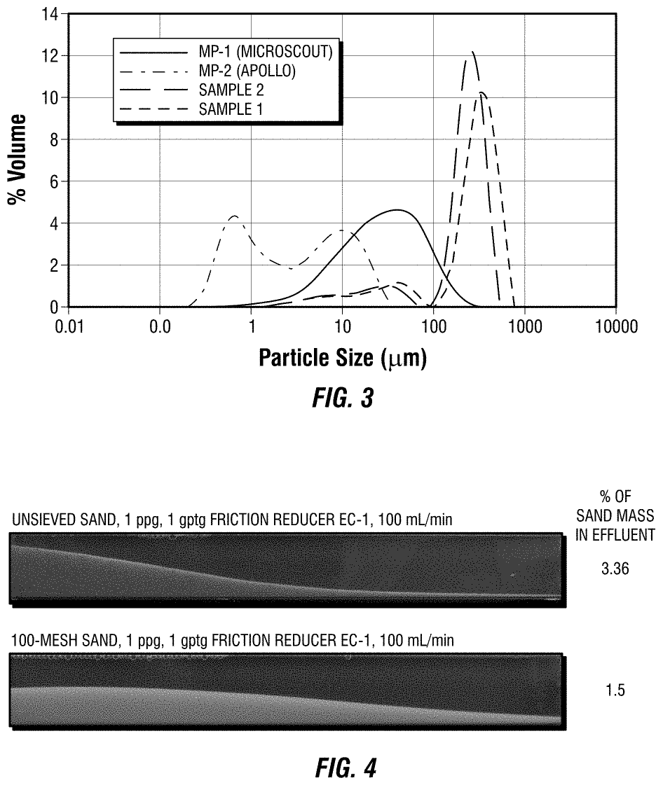

The particle size distribution curves of the unsieved sand samples may be compared to certain existing proppant products as shown in FIG. 3. The particle size distribution curves may be multi-modal. As illustrated, there is overlap volume with Halliburton's micro-proppants available under the tradenames MicroScout® (MP-1) and MicroScout® Plus (MP-2). Each curve depicts separate peaks signifying a larger percentage of that particle size present in a volumetric space. The following table shows the volume percent of unsieved sand that falls within the same particle size distribution of MicroScout and MicroScout Plus. As depicted, the micro-proppant curves show the limited range of particle sizes per source of micro-proppant. MicroScout® has particles ranging between about 0.3 μm to about 400 μm. MicroScout® Plus has particles ranging between about 0.3 μm to about 50 μm. In comparison, the unsieved sand produced from Sample 1 has particles ranging between about 0.3 μm to about 700 μm, wherein there is a higher volume percentage of particles (e.g. 12%) with a particle size of about 400 μm. The unsieved sand produced from Sample 2 has particles ranging between about 0.3 μm to about 900 μm, wherein there is a higher volume percentage of particles (e.g. 10%) with a particle size of about 500 μm. One of ordinary skill in the art, with the benefit of this disclosure, would appreciate that the unsieved sand may be functional to replace a need for micro-proppants as the unsieved sand comprises particles having the same particle sizes as those of the micro-proppants.

TABLE 4

| Commercially Available | % Volume | % Volume |
|---|---|---|
| Micro-proppant | of Sample 1 | of Sample 2 |
| MicroScout ® | 62 | 84 |
| MicroScout ® Plus | 12 | 13 |

### EXAMPLE 2

A portion of sand from Sample 2 discussed above was used in a slot flow test to observe how the sand is placed in a mini-slot model simulating an opening fracture. Sand with a concentration of 1 lbm/gal was mixed in a slickwater prepared with 1 gal/Mgal friction reducer. The fluid was injected at an injection rate of 60 cc/min through the slot and into the simulated fracture. The fine particulates of the sand were observed to readily flow forward and exit the slot, whereas the larger sand particulates tended to settle quickly. This test was reviewed using critical velocity correlations for the transport of sand in horizontal pipe. The sand bed height was determined for a 20/40 mesh size sand with a median diameter of 0.0248 inches in a round pipe with an internal diameter of 5 inches. For a 1 ppg sand concentration with a proppant density of 22.63 lb/gal and a Newtonian fluid with a viscosity of 10 cP and a density of 8.6 ppg, the sand bed height at 5 bpm is 31.75%. A 50/70 mesh size sand with a median diameter of 0.01 inches under the same conditions has a lesser sand bed height, indicating that it would be transported further down the flow path at the same pump rate as the previous example.

FIG. 4 illustrates a comparison between separate slot flow tests as described above using different proppant materials. An embodiment using the unsieved sand is illustrated in the first test (4A). An embodiment using 100 mesh sand is illustrated in the second test (4B). In both tests, all other variables were held constant. The resultant percentage of sand mass in the effluent was determined to be 3.36% for the unsieved sand and 1.5% for the 100 mesh sand.

An embodiment of the present disclosure is a method comprising: providing a treatment fluid comprising a base fluid and unsieved proppant material; introducing the treatment fluid into a well bore penetrating at least a portion of a subterranean formation; and depositing at least a portion of the unsieved proppant material in at least a portion of the subterranean formation.

In one or more embodiments described in the preceding paragraph, the treatment fluid is introduced into the subterranean formation at or above a pressure sufficient to create or enhance at least one fracture in the subterranean formation. In one or more embodiments described above, the at least one fracture comprises one or more microfractures. In one or more embodiments described above, the method further comprises introducing a pad fluid into the well bore prior to introducing the treatment fluid comprising the unsieved proppant material at or above a pressure sufficient to create or enhance at least one fracture in the subterranean formation. In one or more embodiments described above, a particle size distribution of the unsieved proppant material is at least about 0.01 microns and at most about 2,000 microns. In one or more embodiments described above, the unsieved proppant material has undergone a screening process to remove particles having particle sizes greater than about 2 mm. In one or more embodiments described above, the method further comprises introducing a second treatment fluid into the well bore prior to introducing the treatment fluid comprising the unsieved proppant material, wherein the second treatment fluid comprises a high strength proppant material having a particle size smaller than about 30 mesh. In one or more embodiments described above, the method further comprises introducing a third treatment fluid into the well bore after introducing the treatment fluid comprising the unsieved proppant material, wherein the third treatment fluid comprises a high strength proppant material having a particle size larger than about 30 mesh. In one or more embodiments described above, the unsieved proppant material is selected from a group consisting of: drill cuttings, sand, waste material from a sieving operation, ground-up plastics, ground-up rubbers, fly ash, or any combination thereof. In one or more embodiments described above, the unsieved proppant material comprises unsieved sand. In one or more embodiments described above, the unsieved proppant material comprises particles with particle sizes between about 100 microns to about 1 mm in diameter and particles with particle sizes less than about 100 microns in diameter.

Another embodiment of the present disclosure is a method comprising: providing a fracturing fluid comprising a base fluid and unsieved proppant material; and introducing the fracturing fluid into a well bore penetrating at least a portion of a subterranean formation at or above a pressure sufficient to create or enhance one or more fractures in the portion of the subterranean formation.

In one or more embodiments described in the preceding paragraph, the one or more fractures comprise one or more microfractures. In one or more embodiments described above, a particle size distribution of the unsieved proppant material is at least about 0.01 microns and at most about 2,000 microns. In one or more embodiments described above, the unsieved proppant material has undergone a sieving process to remove particles having particle sizes greater than about 2 mm. In one or more embodiments described above, the unsieved proppant material is selected from a group consisting of: drill cuttings, sand, waste material from a sieving operation, ground-up plastics, ground-up rubbers, fly ash, or any combination thereof. In one or more embodiments described above, a particle size distribution of the unsieved proppant material is from about 10 mesh to about 1,000 mesh. In one or more embodiments described above, the unsieved proppant material comprises particles with particle sizes between about 100 microns to about 1 mm in diameter and particles with particle sizes less than about 100 microns in diameter. In one or more embodiments described above, the method further comprises mixing the fracturing fluid using mixing equipment. In one or more embodiments described above, the fracturing fluid is introduced into the subterranean formation using one or more pumps.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

1. A method comprising:
providing a treatment fluid comprising a base fluid and unsieved proppant material, wherein the unsieved proppant material has not undergone a sieving process and has not been filtered or sorted to a designated size, wherein the unsieved proppant material comprises a plurality of different particle sizes;
introducing the treatment fluid into a wellbore penetrating at least a portion of a subterranean formation; and
depositing at least a portion of the unsieved proppant material in at least a portion of the subterranean formation, wherein there is a settling tendency of the unsieved proppant material in the treatment fluid due to gravity, thereby allowing larger particles to settle near the wellbore and allowing smaller particles to be transported further before settling.

2. The method of claim 1, wherein the treatment fluid is introduced into the subterranean formation at or above a pressure sufficient to create or enhance at least one fracture in the subterranean formation.

3. The method of claim 2, wherein the at least one fracture comprises one or more microfractures.

4. The method of claim 2, further comprising introducing a pad fluid into the wellbore prior to introducing the treatment fluid comprising the unsieved proppant material at or above a pressure sufficient to create or enhance at least one fracture in the subterranean formation.

5. (canceled)

6. (canceled)

7. The method of claim 1, further comprising introducing a second treatment fluid into the wellbore prior to introducing the treatment fluid comprising the unsieved proppant material, wherein the second treatment fluid comprises a proppant material having a particle size smaller than about 30 mesh.

8. The method of claim 7, further comprising introducing a third treatment fluid into the wellbore after introducing the treatment fluid comprising the unsieved proppant material, wherein the third treatment fluid comprises a proppant material having a particle size larger than about 30 mesh.

9. The method of claim 1, wherein the unsieved proppant material is selected from a group consisting of: drill cuttings, sand, waste material from a sieving operation, ground-up plastics, ground-up rubbers, fly ash, or any combination thereof.

10. The method of claim 1, wherein the unsieved proppant material comprises unsieved sand.

11. (canceled)

12. A method comprising:
providing a fracturing fluid comprising a base fluid and unsieved proppant material, wherein the unsieved proppant material has not undergone a sieving process and has not been filtered or sorted to a designated size, wherein the unsieved proppant material comprises a plurality of different particle sizes; and
introducing the fracturing fluid into a wellbore penetrating at least a portion of a subterranean formation at or above a pressure sufficient to create or enhance one or more fractures in the portion of the subterranean formation, wherein there is a settling tendency of the unsieved proppant material in the fracturing fluid due to gravity, thereby allowing larger particles to settle near the wellbore and allowing smaller particles to be transported further before settling.

13. The method of claim 12, wherein the one or more fractures comprise one or more microfractures.

14. (canceled)

15. (canceled)

16. The method of claim 12, wherein the unsieved proppant material is selected from a group consisting of: drill cuttings, sand, waste material from a sieving operation, ground-up plastics, ground-up rubbers, fly ash, or any combination thereof.

17. (canceled)

18. (canceled)

19. The method of claim 12, further comprising mixing the fracturing fluid using mixing equipment.

20. The method of claim 12, wherein the fracturing fluid is introduced into the subterranean formation using one or more pumps.

21. The method of claim 12, further comprising introducing a treatment fluid into the wellbore after introducing the fracturing fluid comprising the unsieved proppant material, wherein the treatment fluid comprises a proppant material having a particle size smaller than about 30 mesh.

22. The method of claim 21, further comprising introducing a second treatment fluid into the wellbore after introducing the treatment fluid, wherein the second treatment fluid comprises a proppant material having a particle size larger than about 30 mesh.

23. The method of claim 21, further comprising introducing a pad fluid into the wellbore prior to introducing the treatment fluid at or above a pressure sufficient to create or enhance at least one fracture in the subterranean formation.

24. The method of claim 12, wherein the unsieved proppant material comprises unsieved sand.

25. The method of claim 1, wherein the unsieved proppant material has undergone a washing process to remove clay minerals and impurities.

26. The method of claim 12, wherein the fracturing fluid is a low viscosity fluid having a viscosity of about 20 cP or less.

27. The method of claim 1, wherein the treatment fluid is a low viscosity fluid having a viscosity of about 20 cP or less.
